(19) United States
(12) Patent Application Publication
(10) Pub. No.: US 2023/0191386 A1
(43) Pub. Date: Jun. 22, 2023

(54) COMPRESSED NATURAL GAS COMBUSTION AND EXHAUST SYSTEM

(71) Applicant: Johnson Matthey Public Limited Company, London (GB)

(72) Inventors: Agnes RAJ, Reading (GB); Raj RAJARAM, Reading (GB); Gudmund SMEDLER, Gothenburg (SE); David THOMPSETT, Reading (GB)

(21) Appl. No.: 18/067,932

(22) Filed: Dec. 19, 2022

(30) Foreign Application Priority Data
Dec. 20, 2021 (EP) 21216089.9

(51) Int. Cl. B01J 35/00; B01J 29/80; B01J 29/72; B01J 29/44; B01J 37/02; B01J 35/04; F01N 3/28

(52) U.S. Cl. CPC B01J 35/0006; B01J 29/80; B01J 29/723; B01J 29/44; B01J 37/0246; B01J 35/04; B01J 37/0244; F01N 3/2828; F01N 2370/04

(57) ABSTRACT

The present invention relates to a compressed natural gas combustion and exhaust system comprising: (i) a natural gas combustion engine; and (ii) an exhaust treatment system, the exhaust treatment system comprising a intake for receiving an exhaust gas from the combustion engine and a catalyst article arranged to receive and treat the exhaust gas, wherein the catalyst article comprises: a substrate having at least first and second coatings, the first coating being free from platinum-group-metals and comprising a copper-containing zeolite having the CHA framework-type and the second coating comprising a palladium-containing zeolite, wherein the first coating is arranged to contact the exhaust gas before the second coating. The present invention further relates to a method and a use.

The present invention relates to a compressed natural gas combustion and exhaust system and, in particular, to one which has a Pd on zeolite catalyst with improved light-off performance for NOx, CO and HC. In particular, it relates to such a system having an upstream sulphur trap for realising these performance benefits which is necessary in view of the sulphur present in natural gas.

Natural gas is of increasing interest as an alternative fuel for vehicles and stationary engines that traditionally use gasoline and diesel fuels. Natural gas is composed mainly of methane (typically 70-90%) with variable proportions of other hydrocarbons such as ethane, propane and butane (up to 20% in some deposits) and other gases. It can be commercially produced from oil or natural gas fields and is widely used as a combustion energy source for power generation, industrial cogeneration and domestic heating. It can also be used as a vehicle fuel.

Natural gas can be used as transportation fuel in the form of compressed natural gas (CNG) and liquefied natural gas (LNG). CNG is carried in tanks pressurised to 3600 psi (˜248 bar) and has an energy density around 35% of gasoline per unit volume. LNG has an energy density 2.5 times that of CNG and is mostly used for heavy-duty vehicles. It is cooled to liquid form at −162° C. and as a result the volume is reduced 600 fold meaning LNG is easier to transport than CNG. Bio-LNG could be an alternative to natural (fossil) gas, being produced from biogas, derived by anaerobic digestion from organic matter such as landfill waste or manure.

Natural gas has a number of environmental benefits: it is a cleaner burning fuel typically containing few impurities, it contains higher energy (Bti) per carbon than traditional hydrocarbon fuels resulting in low carbon dioxide emissions (25% less greenhouse gas emissions), and it has lower emissions of PM and NOₓ compared to diesel and gasoline. Biogas could reduce such emissions further.

Further drivers for the adoption of natural gas include high abundance and lower cost compared to other fossil fuels.

Natural gas engines emit very low PM and NOₓ (up to 95% and 70% less, respectively) compared to heavy-duty and light-duty diesel engines. However, exhaust gas produced by NG engines often contains significant quantities of methane (so-called “methane slip”). The regulations which cap emissions from these engines currently include Euro VI and the US Environmental Protection Agency (EPA) greenhouse gas legislation. These impose emissions limits for methane, nitrogen oxides (NOₓ) and particulate matter (PM).

The two main operating modes used for methane fueled engines are stoichiometric conditions (λ=1) and lean burn conditions (λ≥1.3). Palladium-based catalysts are well known as the most active type of catalyst for methane oxidation under both conditions. The regulated emissions limits for both stoichiometric and lean burn compressed natural gas engines can be met by the application of either palladium-rhodium three-way catalyst (TWC) or platinum-palladium oxidation catalyst respectively.

The growth of this Pd based catalyst technology depends on overcoming challenges in terms of cost and catalyst deactivation due to sulphur, water and thermal ageing.

Methane is the least reactive hydrocarbon and high energy is required to break the primary C—H bond. The ignition temperature of alkanes generally decreases with increasing fuel to air ratio and increasing hydrocarbon chain length which correlates with the C—H bond strength. It is known that with Pd-based catalysts, the light-off temperature for methane conversion is higher than for other hydrocarbons (where “light-off temperature” means the temperature at which conversion reaches 50%).

When operating in stoichiometric conditions (λ=1), a TWC is used as an effective and cost efficient after-treatment system to combust methane. Mostly bimetallic Pd—Rh catalysts with high total platinum group metal (pgm) loadings of >200 gft⁻³ are needed for high levels of methane conversion to meet end of life total hydrocarbon (THC) regulations due to the very low reactivity of this hydrocarbon and catalyst deactivation via thermal and chemical effects. Use of high pgm loadings will improve the overall HC conversion in stoichiometric CNG engines. However, high methane conversions can be achieved with relatively low pgm based on engine calibration, i.e. controlling air to fuel ratio so as to operate near stoichiometric or rich of stoichiometric; the pgm loading can also be varied corresponding to the regional legislation requirement with regards to methane and non-methane conversions.

The reduction of NOₓ and oxidation of methane is also more difficult under very oxidising conditions. For lean burn CNG applications, Pd—Pt at high total pgm loadings (>200 gft⁻³) are needed for methane combustion at lower temperatures. Unlike with stoichiometric engines, a reductant also needs to be injected into the exhaust stream in order to be able to reduce NOₓ in the presence of excess oxygen. This is normally in the form of ammonia (NH₃), and thus lean burn applications require a completely different catalyst system to those that are stoichiometric, where efficient NOₓ reduction can be achieved with the use of CO or HC at slightly rich or stoichiometric conditions.

Due to the unreactive (or poorly reactive) nature of methane at lower temperatures, increased methane emissions result during cold start and idle situations, mainly for lean burn where the exhaust temperatures are lower than stoichiometric. In order to improve the reactivity of methane at lower temperatures, one of the options is to use high pgm loadings, which increases costs.

Natural gas catalysts, especially Pd-based catalysts, may suffer from poisoning by water (5-12%) and sulphur (<0.5 ppm SO₂ in lube oil) especially under lean conditions, which results in drastic reduction of conversion rate of the catalyst over time. The deactivation due to water is significant due to the formation of hydroxyl, carbonates, formates and other intermediates on the catalyst surface. The activity is reversible and can be recovered completely if water is removed. However, this is impractical as methane combustion feed always contains a high level of water due to the high content of H in methane.

H₂O can be either an inhibitor or a promoter depending on the air-to-fuel ratio, i.e. lambda. Under stoichiometric and reducing conditions, lambda>1, H₂O can act as a promoter for the oxidation of hydrocarbons through the steam reforming reaction in both CNG and gasoline engines. However for lean burn CNG operating at lambdas>1, H₂O acts as an inhibitor for methane oxidation. It is critical to understand the water inhibition effect and design catalysts which are more tolerant to the presence of H₂O. This would allow for improvement when trying to control methane emissions from lean burn CNG.

Though the sulphur level is very low in the engine exhaust, Pd-based catalysts deactivate significantly upon sulphur exposure due to the formation of stable sulphates. Regeneration of the catalyst in order to restore the activity following sulphur poisoning is challenging and will usually require high temperatures, rich operation or both. This is easily achievable in stoichiometric operation but more difficult in lean burn. A lean burn vehicle operates with a much higher air-to-fuel ratio than a stoichiometric vehicle and will need injection of a much higher concentration of reductant to switch to rich operation. Thermal deactivation resulting from a high level of misfire events due to poor engine transient control and ignition systems destroys the catalyst and correspondingly leads to a high level of exhaust emissions.

The palladium-containing catalyst deactivates under both lean and stoichiometric conditions, but sulphur poisoning has a more dramatic impact than thermal ageing in lean operation. Sulphur poisoning can be improved by the addition of small amounts of Pt to the Pd catalyst. This is because the sulphur inhibition due to formation of palladium sulphates can be reduced significantly on addition of Pt. However, the addition of Pt further increases the costs.

Accordingly, there is a desire for the provision of an improved system for natural gas combustion and exhaust gas treatment to reduce methane emissions by tackling catalyst deactivation, such as by sulphur, water and thermal ageing, without increasing the cost of the catalyst. It is an object of the present invention to address this problem, tackle the disadvantages associated with the prior art, or at least provide a commercially useful alternative thereto.

According to a first aspect there is provided a compressed natural gas combustion and exhaust system comprising:
(i) a natural gas combustion engine and
(ii) an exhaust treatment system, the exhaust treatment system comprising a intake for receiving an exhaust gas from the combustion engine and a catalyst article arranged to receive and treat the exhaust gas, wherein the catalyst article comprises:
a substrate having at least first and second coatings, the first coating being free from platinum-group-metals and comprising a copper-containing zeolite having the CHA framework-type and the second coating comprising a palladium-containing zeolite,
wherein the first coating is arranged to contact the exhaust gas before the second coating.

In the following passages different aspects/embodiments are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

Sulphur components in exhaust derived from fuel and lubricant (in CNG it's the lubricant) poisons the catalyst. Pd supported on a very high SAR zeolite shows excellent activity in the presence of water compared to alumina, however is highly deactivated when exposed to sulphur even in small amounts. Use of sulphur trap materials upstream of the oxidation catalyst is an alternative option to prevent catalyst deactivation over the operating temperatures. This invention relates to the use of a copper-containing zeolite as a sulphur trap for a palladium-containing zeolite catalyst to maintain the high oxidation performance in the presence of sulphur. Copper-containing zeolites are particularly effective for trapping sulphur under humid and sulphur containing conditions, such as those found in CNG systems. Indeed, the copper-containing zeolite effectively traps sulphur to protect the downstream palladium-containing zeolite which is otherwise very vulnerable to deactivation.

The present invention relates to a compressed natural gas combustion and exhaust system comprising a natural gas combustion engine and an exhaust treatment system.

A natural gas combustion engine is an engine used for combusting natural gas. Preferably the natural gas combustion engine is a stationary engine, preferably a gas turbine or a power generation system. In stationary applications, natural gas combustion may be configured to operate constantly under lean or stoichiometric conditions. In such systems the combustion conditions and fuel composition are generally kept constant for long operating times. This means that, compared to mobile applications, there is less opportunity to have a regeneration step to remove sulphur and moisture contaminants. Therefore, the benefits described herein may be of particular benefit for stationary applications. That is, it is especially desirable to provide a catalyst which has high sulphur and moisture tolerance when there are limited opportunities to regenerate the catalyst. It should be appreciated that both lean and stoichiometric system types can be used across a range of different applications.

An exhaust treatment system is a system suitable for treating an exhaust gas from the combustion engine. The exhaust treatment system comprises an intake for receiving an exhaust gas from the combustion engine and a catalyst article arranged to receive and treat the exhaust gas.

A catalyst article is a component suitable for use in an exhaust gas system. Typically such articles are honeycomb monoliths, which may also be referred to as “bricks”. These have a high surface area configuration suitable for contacting the gas to be treated with a catalyst material to effect a transformation or conversion of components of the exhaust gas. Other forms of catalyst article are known and include plate configurations, as well as wrapped metal catalyst substrates. The catalyst article described herein is suitable for use in all of these known forms, but is especially preferred that it takes the form of a honeycomb monolith as these provide a good balance of cost and manufacturing simplicity.

The catalyst article is for the treatment of an exhaust from a natural gas combustion engine. That is, the catalyst article is for the catalytic treatment of exhaust gases from a natural-gas combustion engine in order to convert or transform components of the gases before they are emitted to the atmosphere in order to meet emissions regulations. When natural gas is combusted it will produce both carbon dioxide and water, but the exhaust gas also contains an amount of additional methane (and other short chain hydrocarbons) that needs to be catalytically removed before the exhaust is emitted to the atmosphere. The exhaust gases also typically contain significant amounts of water and sulphur that can build up and deactivate the catalyst.

The catalyst article comprises a substrate having at least first and second coatings. Preferably the first coating is provided as a washcoat on the substrate and/or the second coating is provided as a washcoat on the substrate. Preferably the substrate is a flow-through monolith. Alternatively, the substrate may comprise a first flowthrough monolith and a second flow-through monolith arranged in series, wherein the first flow-through monolith has a first coating, and the second flow-through monolith has a second coating.

The first coating is free from platinum-group-metals and comprises a copper-containing zeolite having the CHA framework-type. Preferably the copper-containing zeolite having the CHA framework-type has:
(i) a SAR of from 15 to 30, preferably from 20 to 25; and/or
(ii) a Cu loading of from 1 to 5 wt %, preferably 2 to 4% and most preferably about 3 wt %.

This particular zeolite effectively traps sulphur present in exhaust gas received from a CNG engine.

Preferably the first coating has a washcoat loading of 1 to 50 g/ft³, more preferably 5 to 40 g/ft³ and most preferably 10 to 30 g/ft³.

The second coating comprises a palladium-containing zeolite. Preferably the palladium-doped zeolite has a SAR of ≥1200, preferably ≥1300, such as ≥1500 (e.g. ≥1700), more preferably ≥2000, such as ≥2200. Such a palladium-containing zeolite demonstrates excellent activity for treatment of exhaust gas from a CNG engine despite the presence of water within the exhaust gas, but is very prone to sulphur inhibition.

Preferably the second coating has a washcoat loading of 1 to 50 g/ft³, more preferably 5 to 40 g/ft³ and most preferably 10 to 30 g/ft³.

The first coating is arranged to contact the exhaust gas before the second coating. This arrangement enables the first coating to trap sulphur present in the exhaust gas such that the exhaust gas received by the second coating has a reduced sulphur content. Consequently, deactivation of the palladium-containing zeolite in the second coating by sulphur is reduced.

Preferably the first coating is upstream of the second coating in a zoned configuration. This permits the first coating to contact the exhaust gas before the second coating.

Preferably the substrate has an inlet end and an outlet end, optionally wherein the first coating extends from the inlet end and the second coating extends from the outlet end.

Preferably the first coating extends from 20 to 80%, preferably 60 to 80% of an axial length of the substrate and/or wherein the second coating extends from 20 to 80%, preferably 20 to 40% of an axial length of the substrate, and/or wherein the first coating and the second coating together substantially cover the substrate.

Preferably the first coating and the second zone overlap by at least 10% of an axial length of the substrate. Preferably the first coating and the second zone overlap by up to 25% of an axial length of the substrate.

Alternatively, the first coating may be arranged on the second coating in a layered configuration. This permits the first coating to contact the exhaust gas before the second coating.

The exhaust gas may have a SOx content of less than 10 ppm.

Preferably the system further comprises an SCR catalyst downstream of the catalytic article. This serves to further treat other elements of the exhaust gas.

According to a further aspect there is provided a method for the treatment of an exhaust from a natural gas combustion engine, the method comprising:
contacting the exhaust with a catalyst article, wherein the catalyst article comprises:
a substrate having at least first and second coatings, the first coating comprising a copper-doped zeolite having the CHA framework-type and the second coating comprising a palladium-doped zeolite,
wherein the first coating is arranged to contact the exhaust gas before the second coating.

Preferably the method described in this aspect can be applied to the system described herein. Accordingly, all features described as preferably for the system apply equally to the method aspect.

According to a further aspect there is provided the use of a copper-doped CHA zeolite in an exhaust system as a sulphur-trap to protect a downstream palladium-containing zeolite catalyst.

Preferably the use described in this aspect can be applied to the method and system described herein. Accordingly, all features described as preferably for the system and method apply equally to the use aspect.

### FIGURES

The invention will be described further in relation to the following non-limiting FIGURES, in which:

FIG. 1 shows the improvement in light-off performance achieved with the present invention.

### EXAMPLES

The invention will now be described further in relation to the following non-limiting examples.

A synthetic gas mixture was flowed through a packed bed of pelletised catalyst beads. In the embodiment representative of the system described herein, 0.1 g of beads comprising a copper-containing zeolite were placed upstream of 0.1 g of palladium-containing-zeolite beads. In a comparative example, the copper-containing zeolite beads were replaced with 0.1 g of inert cordierite beads.

The copper-containing zeolite contained 3 wt % Cu. The zeolite of the copper-containing zeolite was a CHA zeolite with a SAR of 22.

The palladium-containing zeolite contained 3 wt % Pd. The zeolite of the palladium-containing zeolite was a ZSM-5 zeolite having a SAR of 2120.

The synthetic gas mixture comprised ˜2 ppm SO₂, 4000 ppm CH₄, 100 ppm C₂H₆, 35 ppm C₃H₈, 1000 ppm CO, 500 ppm NO, 10% O₂, 10% H₂O, 7% CO₂, balance N₂ at a space velocity of 100,000 h⁻¹ Notably, the synthetic gas mixture has a SO₂ content of ˜2 ppm.

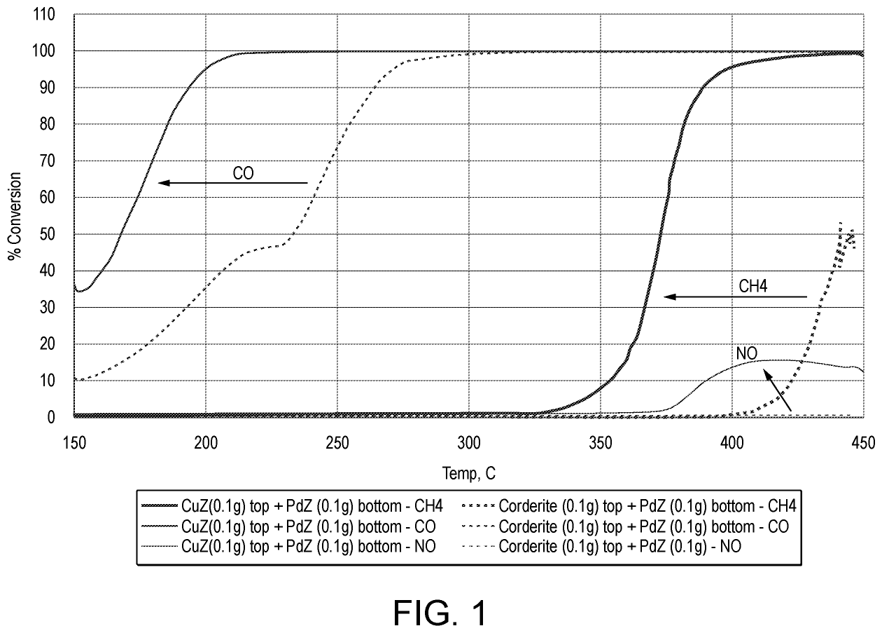

FIG. 1 is a plot of temperature (X-axis) against % conversion of CO, CH₄ and NO. The dashed lines indicate the CO, CH₄ and NO activity of the comparative example. The solid lines indicate the CO, CH₄ and NO activity of the inventive examples.

As can be seen from FIG. 1, the % conversion for CO, CH₄ and NO is significantly greater for the inventive example than the comparative example. For example, the light-off temperature (the temperature at which 50% conversion is achieved) for CO conversion for the inventive example is approximately 170° C. and the light-off temperature for CO conversion for the comparative example is approximately 235° C. Similarly, the light-off temperature for CH₄ conversion for the inventive example is 370° C. and the light-off temperature for CH₄ conversion for the comparative example is approximately 440° C. It can be seen that the peak NO conversion for the inventive example is 15% that is reached at approximately 410° C. Substantially 0% NO conversion was demonstrated for the comparative example.

FIG. 1 therefore demonstrates improved light-off performance for treatment of CO and CH₄ and improved NO activity achieved by the catalyst of the present invention.

The catalyst of the present invention demonstrates such improved performance due to the presence of the upstream copper-containing zeolite, which is particularly effective for trapping sulphur present in the exhaust gas that would otherwise deactivate the downstream palladium-containing catalyst.

The improved performance demonstrated by the catalyst of the present invention is particularly relevant for treatment of an exhaust gas from a CNG engine. Exhaust gas generated by a CNG engine contains significant quantities of methane (so-called “methane slip”) and rely on palladium-containing zeolites for effective methane treatment. However, as demonstrated by the comparative example, such palladium-containing zeolites are susceptible to poisoning by sulphur present in the exhaust stream from a CNG engine (as sulphur is typically present in the lubricant of the CNG engine). The catalyst of the present invention reduces sulphur poisoning of the downstream palladium-containing zeolite, which in turn achieves improved light-off performance for treatment of methane and CO and improved NO activity.

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

It will be understood that, although the terms “first”, “second”, etc. may be used herein to describe various elements, layers and/or portions, the elements, layers and/or portions should not be limited by these terms. These terms are only used to distinguish one element, layer or portion from another, or a further, element, layer or portion. It will be understood that the term “on” is intended to mean “directly on” such that there are no intervening layers between one material being said to be “on” another material. Spatially relative terms, such as “under”, “below”, “beneath”, “lower”, “over”, “above”, “upper” and the like, may be used herein for ease of description to describe one element or feature's relationship to another element(s) or feature(s). It will be understood that the spatially relative terms are intended to encompass different orientations of the device in use or operation in addition to the orientation depicted in the figures. For example, if a device as described herein is turned over, elements described as “under” or “below” other elements or features would then be oriented “over” or “above” the other elements or features. Thus, the example term “under” can encompass both an orientation of over and under. The device may be otherwise oriented and the spatially relative descriptors used herein interpreted accordingly.

The foregoing detailed description has been provided by way of explanation and illustration, and is not intended to limit the scope of the appended claims. Many variations of the presently preferred embodiments illustrated herein will be apparent to one of ordinary skill in the art, and remain within the scope of the appended claims and their equivalents.

1. A compressed natural gas combustion and exhaust system comprising:
(i) a natural gas combustion engine and
(ii) an exhaust treatment system, the exhaust treatment system comprising a intake for receiving an exhaust gas from the combustion engine and a catalyst article arranged to receive and treat the exhaust gas, wherein the catalyst article comprises:
a substrate having at least first and second coatings, the first coating being free from platinum-group-metals and comprising a copper-containing zeolite having the CHA framework-type and the second coating comprising a palladium-containing zeolite,
wherein the first coating is arranged to contact the exhaust gas before the second coating.

2. The system of claim 1, wherein the first coating is provided as a washcoat on the substrate and has a washcoat loading of 1 to 50 g/ft³ and/or wherein the second coating is provided as a washcoat on the substrate and has a washcoat loading of 1 to 50 g/ft³.

3. The system according to claim 1, wherein the copper-containing zeolite having the CHA framework-type has:
(i) a SAR of from 15 to 30; and/or
(ii) a Cu loading of from 1 to 5 wt %.

4. The system of claim 1, wherein the first coating is upstream of the second coating in a zoned configuration.

5. The system of claim 4, wherein the substrate has an inlet end and an outlet end, optionally wherein the first coating extends from the inlet end and the second coating extends from the outlet end.

6. The system of claim 4, wherein the first coating extends from 20 to 80%, preferably 60 to 80% of an axial length of the substrate and/or wherein the second coating extends from 20 to 80%, preferably 20 to 40% of an axial length of the substrate, and/or wherein the first coating and the second coating together substantially cover the substrate.

7. The system of claim 5, wherein the first coating and the second zone overlap by at least 10% of an axial length of the substrate.

8. The system of claim 1, wherein the first coating is arranged on the second coating in a layered configuration.

9. The system of claim 1, wherein the substrate is a flow-through monolith

10. The system of claim 1, wherein the palladium-doped zeolite has a SAR of at least 1500, preferably at least 2000, more preferably at least 2200.

11. The system of claim 1, wherein the exhaust gas has an SOx content of less than 10 ppm.

12. The system of claim 1, further comprising an SCR catalyst downstream of the catalytic article.

13. The system of claim 1, wherein the natural gas combustion engine is a stationary engine.

14. A method for the treatment of an exhaust from a natural gas combustion engine, the method comprising:
contacting the exhaust with a catalyst article, wherein the catalyst article comprises:
a substrate having at least first and second coatings, the first coating comprising a copper-doped zeolite having the CHA framework-type and the second coating comprising a palladium-doped zeolite,
wherein the first coating is arranged to contact the exhaust gas before the second coating.

15. Use of a copper-doped CHA zeolite in an exhaust system as a sulphur-trap to protect a downstream palladium-containing zeolite catalyst.
